(19) United States
(12) Patent Application Publication
(10) Pub. No.: US 2023/0410589 A1
(43) Pub. Date: Dec. 21, 2023

(54) METHOD AND APPARATUS FOR SINGULATING AND DISPENSING BEADS

(71) Applicant: Owens Design, Inc., Fremont, CA (US)

(72) Inventor: Frank Lema, Fremont, CA (US)

(21) Appl. No.: 18/335,670

(22) Filed: Jun. 15, 2023

Related U.S. Application Data
(60) Provisional application No. 63/352,340, filed on Jun. 15, 2022.
(60) Provisional application No. 63/447,159, filed on Feb. 21, 2023.

(51) Int. Cl. G07F 13/02

(52) U.S. Cl. CPC G07F 13/02

(57) ABSTRACT

Devices and methods are disclosed for singulating and dispensing a bead. A pocket formed in a primary nest retains a single bead drawn by vacuum from a bulk hopper such that rotation of the primary nest delivers the single bead to an ejection position. At the ejection position, the bead may be delivered to a transfer tube that carries it to a bead receiver. Alternatively, the bead may be delivered directly to the bead receiver from the primary nest or via transfer to a secondary rotating nest. One or both sides of the bead may be examined for defects using inspection ports in the primary and secondary nests.

### RELATED APPLICATIONS

This application claims priority to U.S. Provisional Application Nos. 63/352,340, filed Jun. 15, 2022, and 63/447,159, filed Feb. 21, 2023. The priorities of this application are expressly claimed, and the disclosures of each provisional application are hereby incorporated by reference in their entirety.

### FIELD OF THE PRESENT DISCLOSURE

This disclosure relates to devices and techniques for separating and delivering fragile objects such as lyophilized beads to a desired location.

### BACKGROUND

Lyophilization is a process for sublimating water from a frozen product under a vacuum colloquially known as “freeze-drying” and has been widely adopted in the pharmaceutical industry. Benefits associated with this process include enhanced stability of the product and ready reconstitution while minimizing risk of heat degradation. One example of lyophilization applies the process to a liquid droplet to form a lyophilized bead, also termed a lyobead. Despite the advantages noted above, lyobeads can be very difficult to reliably separate, control and transfer without high risk of damage due to their static properties, low mass and delicate nature. Consequently, current methods of bead delivery create high levels of bead damage, are unreliable and/or require multiple steps to separate beads. Another drawback of current methods is the inability to inspect the beads partially or fully prior to placement.

For context, one conventional method for separating and dispensing lyobeads relies on a vacuum source to pick and place individual beads. A vacuum end effector is used to pick up and transfer pre-separated beads. Such techniques require a relatively high vacuum and minimal leakage to securely hold the beads, which increases the potential of bead damage either because of vacuum cup force when picking or indentations created by the vacuum cup. Moreover, due to the low mass and high static properties of the beads, this method requires an additional step to separate single beads prior to the vacuum pickup. Another conventional technique involves a shearing technique employing pressurized air or another mechanical mechanism, as depicted in FIG. 1. In this method, a vertical tube 10 allows beads to be stacked and air pressure is used to separate singular beads through a perpendicular horizontal tube 14 as schematically indicated. The method requires a precise fit between the feed tube and beads and tends to be unreliable due to the low mass and static properties of beads. For example, beads slide against each other during the shearing process causing damage and fragmentation. Beads can also stack off center, requiring higher force to shear which increases the chance of damage. Further, debris from damaged beads can jam the feeder or contaminate the separated bead output feed which undermines accuracy of the bead dosage.

Accordingly, it would be desirable to provide a method and apparatus for reliably separating individual highly fragile objects such as lyobeads from bulk and delivering them to a precise location undamaged. It would also be desirable to facilitate automation, allow inspection of the lyobeads during singulation and provide precise dosages during delivery. As will be detailed in the following materials, the bead singulator and dispensers of this disclosure satisfies these and other needs.

### SUMMARY

This disclosure is directed to a bead singulator and dispenser that features a bulk hopper configured to hold and present a plurality of beads, a primary nest, a pocket formed in the primary nest and configured to retain a single bead and a manipulation port routed through the primary nest that is coupled to the pocket. The primary nest is rotatable from a pickup position with the pocket oriented towards the bulk hopper to an ejection position.

In one aspect, the bead singulator and dispenser may have a vacuum source coupled to the manipulation port that is configured to pull a single bead into the pocket when the primary nest is in the pickup position. The bead singulator and dispenser may also have an air pressure source coupled to the manipulation port that is configured to eject a single bead retained within the pocket when the primary nest is in the ejection position.

In one aspect, the bead singulator and dispenser may have a separation port zone, wherein the pocket is configured to pass the separation port zone as the primary nest is rotated from the pickup position to the ejection position and wherein the separation port zone comprises at least one pressurized air orifice.

In one aspect, the bead singulator and dispenser may have a transfer tube with an inlet adjacent to the pocket when the primary nest is in the ejection position. The transfer tube may have an outlet configured to be positioned adjacent to a desired location of a bead receiver.

In one aspect, the primary nest may have a first inspection port such that the primary nest is configured to rotate the pocket past the first inspection port prior to reaching the ejection position. The primary nest may also have a first rejection port such that the primary nest is configured to rotate the pocket past the rejection port after passing the inspection port.

In one aspect, the bead singulator and dispenser may have a secondary nest with a pocket configured to retain a single bead and a manipulation port coupled to the pocket, such that the secondary nest is rotatable from a pickup position with the pocket of secondary nest adjacent the pocket of the primary nest to an ejection position. Correspondingly, the primary nest may have a first rejection port such that the primary nest is configured to rotate the pocket of the primary nest past the first rejection port after passing the first inspection port and the secondary nest may have a second rejection port such that the secondary nest is configured to rotate the pocket of the secondary nest past the second rejection port after passing the second inspection port.

This disclosure is also directed to a method for singulating and dispensing one bead from a plurality of beads. The method may involve providing a bulk hopper having a plurality of beads and an outlet, orienting a primary nest in a pickup position such that a pocket formed in the primary nest is adjacent the outlet of the bulk hopper, retaining a single bead within the pocket by drawing a vacuum through a manipulation port routed through the primary nest that is coupled to the pocket, rotating the primary nest from a pickup position to an ejection position and ejecting the retained single bead by supplying pressurized air through the manipulation port.

In one aspect, pressurized air may be supplied through at least one orifice at a separation port zone as the primary nest is rotated from the pickup position to the ejection position.

In one aspect, ejecting the retained single bead may involve delivering the ejected bead into a transfer tube, such that the transfer tube has an inlet adjacent the pocket when the primary nest is in the ejection position. The position of an outlet of the transfer tube may be adjusted relative to a bead receiver. An exhaust gap between the outlet of the transfer tube and the bead receiver may be provided such that the exhaust gap is configured to cause a desired deceleration of the ejected bead.

In one aspect, ejecting the retained single bead may involve orienting the pocket towards a bead receiver.

In one aspect, the pocket of the primary nest may be rotated subsequently past a first inspection port to allow examination of an exposed side of the retained single bead and a first rejection port prior to reaching the ejection position.

In one aspect, ejecting the retained single bead may involve orienting the pocket of the primary nest towards a secondary nest having a pocket configured to retain a single bead and a manipulation port coupled to the pocket so that the ejected bead is deposited within the pocket of the secondary nest. The secondary nest may be rotated from a pickup position with the pocket of secondary nest adjacent the pocket of the primary nest to an ejection position. Pressurized air may be supplied through the manipulation port of the secondary nest when the secondary nest is in the ejection position to deliver the ejected bead to a bead receiver.

In one aspect, the pocket of the primary nest may be rotated subsequently past a first inspection port to allow examination of an exposed side of the retained single bead and a first rejection port prior to reaching the ejection position of the primary nest and the pocket of the secondary nest may be rotated subsequently past a second inspection port to allow examination of an opposing side of the retained single bead and a second rejection port prior to reaching the ejection position of the secondary nest, such that the opposing side of the retained single bead is exposed when transferred from the pocket of the primary nest to the pocket of the secondary nest.

### BRIEF DESCRIPTION OF THE DRAWINGS

Further features and advantages will become apparent from the following and more particular description of the preferred embodiments of the disclosure, as illustrated in the accompanying drawings, and in which like referenced characters generally refer to the same parts or elements throughout the views, and in which:

FIG. 1 is a schematic depiction of a prior art shearing technique for separating and dispensing beads.

FIG. 2 an elevational view, partially in section, of a bead singulator and dispenser according to an embodiment.

FIGS. 3A and 3B are detail views that schematically illustrate the separation and delivery of singular beads according to an embodiment.

FIG. 4 schematically illustrates the delivery of separated beads according to an embodiment.

FIGS. 5A and 5B are schematic views of a distal end of a bead singulator and dispenser having primary and secondary rotating nests according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings. These and similar directional terms should not be construed to limit the scope of the disclosure in any manner.

Unless defined otherwise, all technical and scientific terms used herein have the same meaning as commonly understood by one having ordinary skill in the art to which the disclosure pertains. Moreover, as used in this specification and the appended claims, the singular forms “a,” “an” and “the” include plural referents unless the content clearly dictates otherwise.

As discussed below, embodiments of this disclosure combine the use of vacuum, air and a protection nest to gently separate, transfer and place the beads. A rotating nest is employed to pick up and thereby separate a single bead using a shaped vacuum pocket or pockets. The bead is rotated from the pickup position to an ejection position past a separation port zone where low-pressure bursts of air act to dislodge any unwanted items. If desired, the system pauses to present the bead for visual or laser sensor inspection, with some embodiments providing a 360-degree inspection of the bead prior to placement.

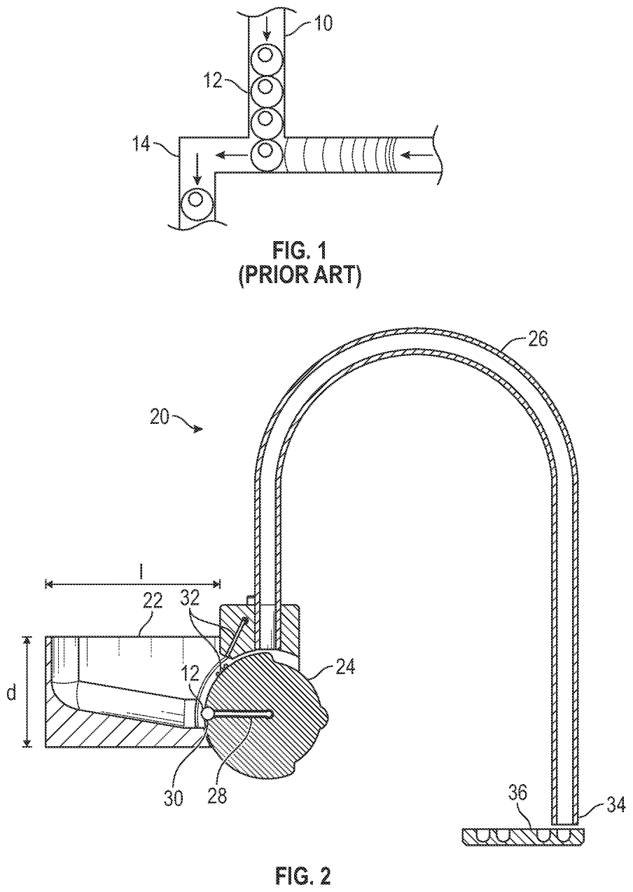

Referring first to FIG. 2, bead singulator and dispenser 20 is shown to include bulk hopper 22, primary rotating nest 24 and transfer tube 26. Items not shown for the sake of clarity include a drive mechanism (which can be either motorized or pneumatic), any necessary controls and a suitable enclosure. The design of bulk hopper 22 can vary in depth “d”, width and length “l” (with the depth “d” and length “l” dimensions shown in this view) to accommodate required number of beads based on bead size and runtime required. In one exemplary embodiment, approximate internal dimensions of bulk hopper 22 may be approximately 3″ length×1″ width×1″ depth. One of skill in the art will appreciate these dimensions can be increased or decreased as desired due to the available footprint and intended runtime between loads. In some applications, bulk hopper 22 may also feature a locking cover that requires a barcode scan of the container being processed or other security mechanism to ensure beads can only be loaded into the correct hopper when multiple bead singulator and dispensers are present. Further, bulk hopper 22 is also configured with large radiuses and slight angle to position the beads close to manipulation port 28 for singulation.

Primary nest 24 has one or more pockets 30 that are coupled to manipulation port 28 and may be customized based on the size and shape of the beads being processed. Providing a plurality of pockets, side by side, enables placement of multiple beads at the same time for higher throughput. Typical beads can range between 1 mm to 5 mm in diameter and some beads may have unique features like a flat spot or non-spherical shape. Accordingly, the depth of pocket 30 may be configured with a size and shape so that only one bead can fit with a very slight protrusion above the surface driven by the bead's size and shape. The width/diameter of pocket 30 may be slightly oversized with smooth radius entry edges to avoid damage to the bead when being pulled in by vacuum while preventing more than one bead from entering.

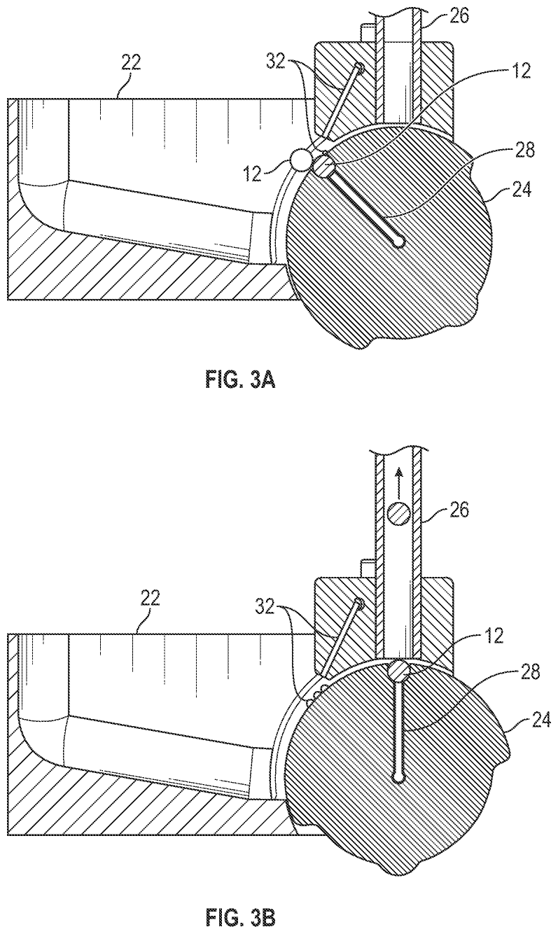

During operation, rotating nest 24 is initially oriented towards the outlet of bulk hopper 22 in a pickup position. A vacuum source is coupled to manipulation port 28 and acts to attract any nearby beads from bulk hopper 22, pulling a single bead 12 into pocket 30. Bulk hopper 22 may be configured to have adjustable feed ramp width to prevent beads from jamming prior to entering pocket 30. Once bead 12 is fully seated in pocket 30 of primary nest 24 as confirmed by an optical or proximity sensor or vacuum sensor at vacuum source 28, nest 24 rotates clockwise as schematically indicated in the detail view of FIG. 3A. As nest 24, rotates, bead 12 is separated from the supply provided by bulk hopper 22 but neighboring beads 12′, manufacturing debris or other particles may still be associated due to vacuum leakage and/or static properties. Separation ports 32 are provided in a zone intermediate between the pickup position are orifices for pressurized air and may be programmed to blow a low pressure burst of air to dislodge any items attached due to vacuum leakage or static while pocket 30 protects the selected bead 12 from being dislodged. As shown, separation ports 32 may be aligned both in line with the direction of rotation of nest 24 and perpendicularly. One of skill in the art will appreciate that this represents a non-contact and gentle method of removing any attached items which are not constrained during the low pressure blow off. This helps ensure that only a single bead is selected for delivery and represents an advantage over the conventional techniques discussed above as it greatly reduces the risk of damage to the beads and unlike the other methods, any if damage occurs, it will not impact subsequent bead pickup.

After further rotation, primary nest 24 reaches the ejection position schematically indicated by FIG. 3B, with bead 12 adjacent an inlet opening of transfer tube 26, the vacuum supply to manipulation port 28 is turned off and a quick short burst of pressurized air is applied through manipulation port 28 to eject bead 12 into transfer tube 26 to deliver the bead to its intended location. The timing and amount of air burst may be controlled by a venturi vacuum generator with built in pressure reservoir and triggered by check valve when pressure is removed from the generator, by controlling respective vacuum and air pressure valves, or by any other suitable technique. Rotation speed of nest 24 between the pickup point adjacent bulk hopper 22 and the ejection position can be adjusted as warranted by the slowdown or pause at the separation port zone needed to dislodge the unwanted material, such as approximately 0.5 seconds up to 2.0 seconds, although other speeds may also be employed.

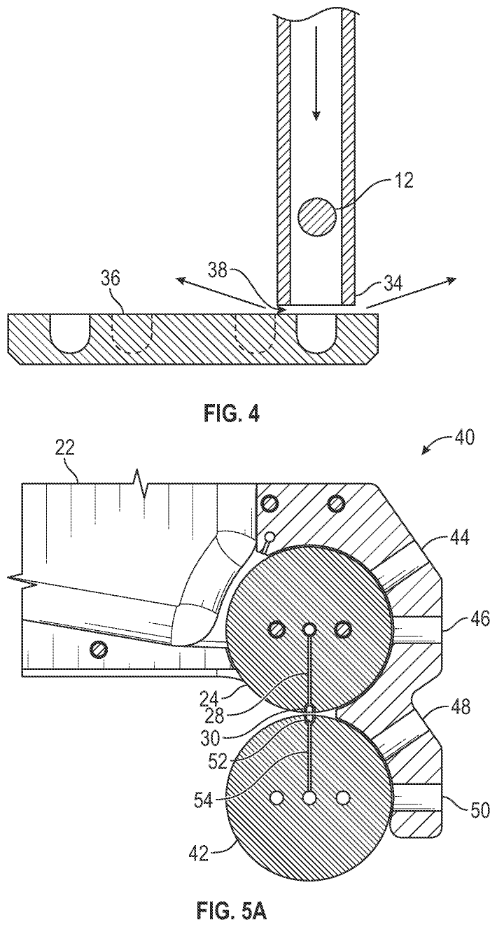

Returning to FIG. 2, transfer tube 26 terminates with an outlet at delivery port 34 where the bead is ejected after singulation. It will be appreciated that transfer tube 26 may be fixed so that bead receiver 36 is moved into position or may be moveable and potentially under automation to adjust the position of delivery port 34 relative to a fixed bead receiver 36. An important aspect in bead delivery is the deceleration of the bead as it is being deposited in receiver 36. Exhaust gap 38 as shown in the detail view of FIG. 4 controls the escape of air to decelerate bead 12 prior to entering final position on receiver 36, which helps determine deceleration along with the amount of ejection pressure, length of delivery tube and the configuration of bead receiver 36. Accordingly, variables that may be adjusted depending on the size and shape of the bead being processed include:
Vacuum rate, controlled by pressure regulator supplying air flow to a venturi vacuum generator
Separation port size, pressure and timing, controlled by regulator, software and design
Ejection port pressure, controlled by regulator
Nest depth, diameter and shape, controlled by design

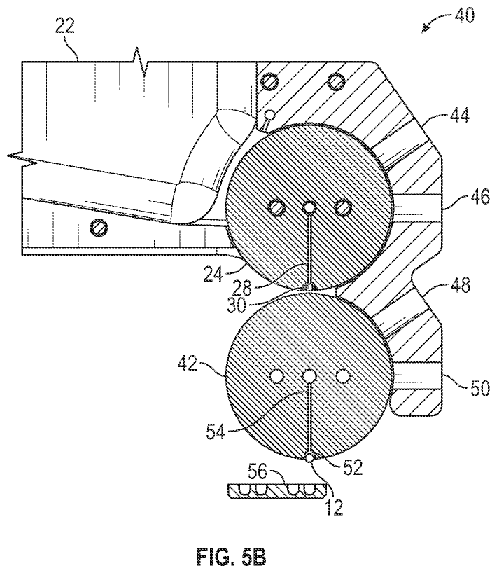

An alternate embodiment is shown in FIGS. 5A and 5B, in which bead singulator and dispenser 40 omits transfer tube 26. Instead, a singulated bead may be delivered either directly from primary rotating nest 24 or following a subsequent transfer to an optional secondary nest 42. Delivery directly from primary nest 24 may be effected by positioning bead receiver 36 underneath nest 24 so that bead 12 may be dispensed using a combination of air supplied through manipulation port 28 and gravity. Since this embodiment eliminates the need for travel through a transfer tube, impact and air turbulence are reduced. Notably, a reduced amount of air is necessary to gently transfer the bead from pocket 30 to bead receiver 36. In many applications, the bead is deposited into a closed pocket and excessive air during the transfer will interact with the pocket and the surrounding objects to create turbulence, potentially blowing the bead (and adjacent items) away from the desired location such that reducing the volume and speed of the air used for delivery may be beneficial.

In this embodiment, primary nest 24 may pause at first inspection port 44 for visualization with a camera or other suitable sensor to determine if the bead passes or fails the necessary criteria. Nest 24 may then rotate the bead past an optional first rejection port 46 through which bead 12 is delivered if inspection fails. After passing first rejection port 46, nest 24 is rotated to the ejection position indicated by FIG. 5A with manipulation port 28 oriented downwards. Secondary nest 42 may be employed when a full 360-degree inspection is desired and features pocket 52 and manipulation port 54 which are similarly configured to those components of primary nest 24. As discussed above, first inspection port 44 allows visualization of the side of bead 12 exposed when seated in pocket 30. After passing inspection and rotation of nest 24 to the position shown in FIG. 5A, bead 12 can then be passed to pocket 52 of secondary nest 42 which is positioned adjacent pocket 30 when primary nest 24 is in the ejection position. Correspondingly, when bead 12 is seated in pocket 52 of secondary nest 42, the opposite side is now exposed. Subsequently, nest 42 may then be rotated past second inspection port 48 and second rejection port 50. Beads rejected by inspection can be removed by either providing a burst of air from either manipulation port 28 or 54 or pulling a vacuum from either rejection port 46 or 50, which also aids in removing any loose particles. If both inspections pass, rotation of secondary nest 42 can be completed to an ejection position with manipulation port 54 oriented downward in the configuration shown in FIG. 5B so bead 12 can be deposited in receiver 36 using a combination of air flow and gravity in a similar manner to that described above.

The bead singulator and dispensers of this disclosure can be implemented into process flows in any suitable manner. In one non-limiting illustration, bead singulator and dispenser 20 or 40 may be configured as a tabletop unit where an operator would manually place bead receiver 36 to be loaded on to a fixed tooling nest and perform the operations discussed above to dispense a single bead into the device. This unit could accommodate multiple feeders and nests to populate the device with more than one bead or chemistries without cross contamination. As another example, one or more bead singulator and dispensers of this disclosure may be incorporated into a semi-automated tool. In this scenario, an operator would place a tray, stack or other pattern of bead receivers 36 to be populated at the input and fill bulk hopper 22 with beads to be singulated. The system based on the software program would proceed to index and populate each pocket of the bead receivers with the desired beads. Yet another example involves integrating bead singulator and dispensers into a larger, fully automated system which would dispense beads to desired locations along with other processes (sealing, assembling, sorting and inspecting).

The exemplary embodiments disclosed above are merely intended to illustrate the various utilities of this disclosure. It is understood that numerous modifications, variations and combinations of functional elements and features of the present disclosure are possible in light of the above teachings and, therefore, within the scope of the appended claims, the present disclosure may be practiced otherwise than as particularly disclosed and the principles of this disclosure can be extended easily with appropriate modifications to other applications.

All patents and publications are herein incorporated for reference to the same extent as if each individual publication was specifically and individually indicated to be incorporated by reference. It should be understood that although the present disclosure has been specifically disclosed by preferred embodiments and optional features, modification and variation of the concepts herein disclosed may be resorted by those skilled in the art, and that such modifications and variations are considered to be within the scope of this disclosure.

What is claimed is:

1. A bead singulator and dispenser comprising:
a bulk hopper configured to hold and present a plurality of beads;
a primary nest;
a pocket formed in the primary nest and configured to retain a single bead; and
a manipulation port routed through the primary nest that is coupled to the pocket;
wherein the primary nest is rotatable from a pickup position with the pocket oriented towards the bulk hopper to an ejection position.

2. The bead singulator and dispenser of claim 1, further comprising a vacuum source coupled to the manipulation port that is configured to pull a single bead into the pocket when the primary nest is in the pickup position.

3. The bead singulator and dispenser of claim 2, further comprising an air pressure source coupled to the manipulation port that is configured to eject a single bead retained within the pocket when the primary nest is in the ejection position.

4. The bead singulator and dispenser of claim 1, further comprising a separation port zone, wherein the pocket is configured to pass the separation port zone as the primary nest is rotated from the pickup position to the ejection position and wherein the separation port zone comprises at least one pressurized air orifice.

5. The bead singulator and dispenser of claim 1, further comprising a transfer tube having an inlet adjacent the pocket when the primary nest is in the ejection position.

6. The bead singulator and dispenser of claim 5, wherein the transfer tube has an outlet configured to be positioned adjacent a desired location of a bead receiver.

7. The bead singulator and dispenser of claim 1, wherein the primary nest further comprises a first inspection port and wherein the primary nest is configured to rotate the pocket past the first inspection port prior to reaching the ejection position.

8. The bead singulator and dispenser of claim 7, wherein the primary nest further comprises a first rejection port such that the primary nest is configured to rotate the pocket past the rejection port after passing the inspection port.

9. The bead singulator and dispenser of claim 1, further comprising a secondary nest having a pocket configured to retain a single bead and a manipulation port coupled to the pocket, wherein the secondary nest is rotatable from a pickup position with the pocket of secondary nest adjacent the pocket of the primary nest to an ejection position.

10. The bead singulator and dispenser of claim 9, wherein the primary nest further comprises a first rejection port such that the primary nest is configured to rotate the pocket of the primary nest past the first rejection port after passing the first inspection port and wherein the secondary nest further comprises a second rejection port such that the secondary nest is configured to rotate the pocket of the secondary nest past the second rejection port after passing the second inspection port.

11. A method for singulating and dispensing one bead from a plurality of beads comprising:
providing a bulk hopper having a plurality of beads and an outlet;
orienting a primary nest in a pickup position such that a pocket formed in the primary nest is adjacent the outlet of the bulk hopper;
retaining a single bead within the pocket by drawing a vacuum through a manipulation port routed through the primary nest that is coupled to the pocket;
rotating the primary nest from a pickup position to an ejection position; and
ejecting the retained single bead by supplying pressurized air through the manipulation port.

12. The method of claim 11, further comprising supplying pressurized air through at least one orifice at a separation port zone as the primary nest is rotated from the pickup position to the ejection position.

13. The method of claim 11, wherein ejecting the retained single bead further comprises delivering the ejected bead into a transfer tube, wherein the transfer tube has an inlet adjacent the pocket when the primary nest is in the ejection position.

14. The method of claim 13, further comprising adjusting the position of an outlet of the transfer tube relative to a bead receiver.

15. The method of claim 14, further comprising providing an exhaust gap between the outlet of the transfer tube and the bead receiver, wherein the exhaust gap is configured to cause a desired deceleration of the ejected bead.

16. The method of claim 11, wherein ejecting the retained single bead comprises orienting the pocket of the primary nest towards a bead receiver.

17. The method of claim 11, further comprising rotating the pocket of the primary nest subsequently past a first inspection port to allow examination of an exposed side of the retained single bead and a first rejection port prior to reaching the ejection position.

18. The method of claim 11, wherein ejecting the retained single bead comprises orienting the pocket of the primary nest towards a secondary nest having a pocket configured to retain a single bead and a manipulation port coupled to the pocket so that the ejected bead is deposited within the pocket of the secondary nest, further comprising rotating the secondary nest from a pickup position with the pocket of secondary nest adjacent the pocket of the primary nest to an ejection position.

19. The method of claim 18, further comprising supplying pressurized air through the manipulation port of the secondary nest when the secondary nest is in the ejection position to deliver the ejected bead to a bead receiver.

20. The method of claim 18, further comprising:
rotating the pocket of the primary nest subsequently past a first inspection port to allow examination of an exposed side of the retained single bead and a first rejection port prior to reaching the ejection position of the primary nest; and
rotating the pocket of the secondary nest subsequently past a second inspection port to allow examination of an opposing side of the retained single bead and a second rejection port prior to reaching the ejection position of the secondary nest, wherein the opposing side of the retained single bead is exposed when transferred from the pocket of the primary nest to the pocket of the secondary nest.
